(19) United States
(12) Patent Application Publication
(10) Pub. No.: US 2009/0047651 A1
(43) Pub. Date: Feb. 19, 2009

(54) Method and apparatus for presenting queries and rewarding correct answers

(76) Inventor: Stanley Sotnikov, Alpharetta, GA (US)

Correspondence Address: RAYMOND R. MOSER JR., ESQ.;MOSER IP LAW GROUP, 1030 BROAD STREET, 2ND FLOOR, SHREWSBURY, NJ, 07702, US

(21) Appl. No.: 11/891,933

(22) Filed: Aug. 14, 2007

(51) Int. Cl. G09B 7/00

(52) U.S. Cl. 434/353

(57) ABSTRACT

A method and apparatus comprising at least one reward retainer for retaining an article, and a controller for presenting at least one query, for receiving at least one answer to the at least one query, and for providing access to the reward retainer in response to the correct answer to the at least one query.

### BACKGROUND OF THE INVENTION

1. Field of the Invention

Embodiments of the present invention generally relate to a method and apparatus for teaching using a reward based system, and more particularly, a method and apparatus for presenting at least one query and rewarding correct answers.

2. Description of the Related Art

In most learning techniques, a teacher provides a student repetitive queries and the student is expected to correctly answer the queries from memory. Answering such queries may be repetitive and unexciting. The queries may relate to information that a person is required to learn. Such queries may be mathematical, scientific, historical, or the like. Learning such information may not have an immediate reward, and thus, a person may be more inclined to postpone learning such information. As a result, teaching such information may be challenging and may require patience.

Therefore, there is a need for a method and/or apparatus for presenting at least one query and rewarding correct answers.

### SUMMARY OF THE INVENTION

Embodiment of the present invention is a method and apparatus for presenting at least one query. The apparatus comprises at least one reward retainer for retaining an article, and a controller for presenting at least one query, for receiving at least one answer to the at least one query, and for providing access to the reward retainer in response to the correct answer to the at least one query.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of an apparatus for presenting at least one query and rewarding correct answers in accordance with one embodiment of the invention;

FIG. 2 is a second perspective view of the apparatus of FIG. 1 wherein a reward retainer is open;

FIG. 3 is a block diagram of a computer system for the apparatus of FIGS. 1 and 2 in accordance with one embodiment of the invention;

FIG. 4 is a flow diagram depicting an exemplary embodiment of a method for presenting at least one query and rewarding correct answers; and

FIG. 5 is a flow diagram depicting an exemplary embodiment of a method for utilizing the apparatus for presenting at least one query and rewarding correct answers.

### DETAILED DESCRIPTION

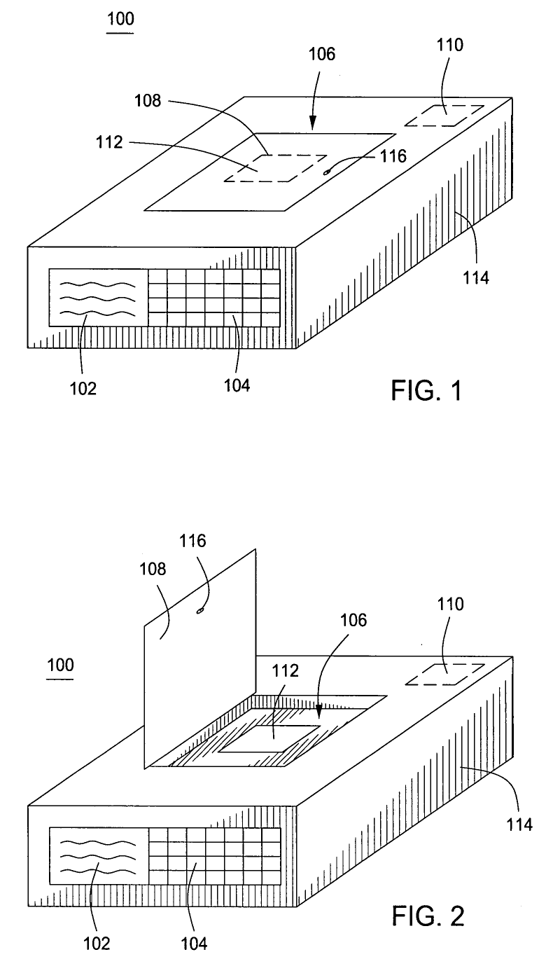

FIG. 1 is a perspective view of an apparatus 100 for presenting at least one query and rewarding correct answers. FIG. 2 is a perspective view of the embodiment of FIG. 1 having a reward retainer 106 being in an open position, while in FIG. 1 the reward retainer 106 is closed. FIG. 1 and FIG. 2 only portray one embodiment of a myriad of possible embodiments of the apparatus 100.

Referring simultaneously to the FIG. 1 and FIG. 2, the apparatus 100 includes a housing 114, an output device 102, an input device 104, a reward retainer 106, and a controller 110. The housing 114 may be any shape, such as but not limited to, a cubical shape, a round shape, an animated shape, a computer apparatus, or the like. The housing 114 may be made of any material, such as, metal, plastic, wood, or the like.

In one embodiment of the invention, a reward article is positioned in a reward retainer 106 comprising a cavity 112 and a closing element 108. The closing element 108 is closed and latched to retain the article in the cavity 112. As queries appear on the output device 102, a user manipulates the input device 104 to answer the queries. Upon answering a predefined number of queries correctly, the closing element 108 is automatically unlatched to expose the cavity 112 and its contents (e.g., the reward article) to the user. In one embodiment, the apparatus 100 may include multiple reward retainers 106 and/or multiple cavities 112 within the retainer 106. A correct answer may allow access to articles in one or more of the reward retainer 106 and/or the cavity 112. In another embodiment, a correct answer to a query may allow access to an article in a first reward retainer 106 and/or cavity 112, and a correct answer to another query may allow access to a second article in a second reward retainer 106 and/or cavity 112.

The output device 102 and the input device 104 may be placed any where on the apparatus 100, may be separate devices coupled to the apparatus 100, or may be devices that are detachable and/or attachable from/to the apparatus 100. The output device 102 may be an audio, video, graphical, printer, LCD, LED display, combination thereof, or the like. The output device 102 may be utilized to output queries already archived in the controller 110. The output device 102 may output answers archived in the controller 110, information about the apparatus 100, information relating to a query, query statistics, user information, controller information, and the like. The apparatus 100 may include any number of output devices 102. For example, the apparatus 100 may allow multiple users to simultaneously utilize the same apparatus 100, each user using a separate output device 102. In addition, the apparatus 100 may allow different users to simultaneously utilize the same output device 102 and operate the same apparatus 100. The users of the apparatus 100 may be in the same location or different locations. The users of the apparatus 100 may utilize an output device 102 placed in a remote location from the apparatus 100.

The input device 104 may be any device that allows a user to enter data to the controller 110, to the output device 102, and/or to answer a query. The input device 104 may be a touch screen, a keypad, and/or any object that provides information or data to the controller 110 and/or the output device 102. The apparatus 100 may include multiple input devices 104. For example, the apparatus 100 may include an input device 104 for inputting queries, for answering queries, for inputting user information and the like. In another embodiment, the apparatus 100 may allow multiple users to simultaneously utilize the same apparatus 100, each user using a separate input device 104. In addition, the apparatus 100 may allow different users to simultaneously utilize the same input device 104 and operate the same apparatus 100. The users of the apparatus 100 may be in the same location or different locations. The users of the apparatus 100 may utilize an input device 104 placed in a remote location from the apparatus 100.

The reward retainer 106 may be any location on the apparatus 100. For example, the retainer 106 may be in, on, within, coupled to the apparatus 100. The retainer 106 may be any shape or reward retainer that holds any article of any shape or size. In the embodiment shown in FIGS. 1 and 2, the reward retainer 106 is a cavity 112 covered by a door 108. The reward retainer 106 has a closing element such as a door 108 for restricting access to an article placed in the reward retainer 106. In FIG. 1, the closing element 108 is shown in the closed state, thus, an article placed in the reward retainer 106 is not accessible to, for example, a student. In FIG. 2, the closing element 108 is shown in the open state, thus, an article placed in the reward retainer 106 is accessible. The closing element 108 may be a flap, straps, a cage, or any element that restricts access to an article placed in the reward retainer 106. The closing element 108 may include a locking mechanism 116 shown in FIG. 1 and FIG. 2. The locking mechanism 116 may be a electromechanical lock, magnetic latch, digital lock, screws, buckle, tabs or the like.

The apparatus 100 may be utilized as a teaching apparatus, as an entertainment apparatus, or the like. The apparatus 100 enables a user to input queries via the input device 104, such as, mathematical queries, historical queries, literature queries, and the like. The user of the apparatus may enter any number of queries at a time. The queries may be answered by the same user or another user. The queries may relate to the same subject or different subjects. As such, the user answering the queries may utilize the apparatus 100 to learn about any subject.

The queries may be entered by the user answering the queries, by another user, readily available (pre-stored) queries, and/or a combination thereof. The queries may be divided by subject matter, may be randomly selected, and/or may be selected by difficulty level, a combination thereof, and the like. For example, a user may select to answer mathematical queries that are for a beginner difficulty level, literature queries for an intermediate difficulty level, and history queries for an advanced difficulty level, and/or the combination thereof.

In one embodiment, an article is placed in the reward retainer 106. The user may be informed of the article via the output device 102 and/or the article may be displayed by the reward retainer 106. The user may not access the article unless a predetermined number of queries are answered correctly. The output device 102 may display a query, such as, a mathematical query. The user may use an input device 104 to answer the queries presented on the output device 102. When the user correctly answers the predetermined number of queries, the closing element 108 opens and/or the locking device 116 unlocks. Thus, the user may have access to the article in the reward retainer 106.

In another embodiment, the apparatus 100 may be coupled to a computer system. The apparatus 100 may utilize the computer system's resources, such as, memory, output device, input device, and the like. As such, the computer's input device, such as, a keyboard, a mouse, or the like, and the computer's output device, such as, a display device, a printer, or the like, form the input and output devices for the apparatus 100. The apparatus 100 may be coupled to the computer via a standard communication port, such as, a universal serial bus (USB), SCSI, interface, wireless interface, WiFi and the like.

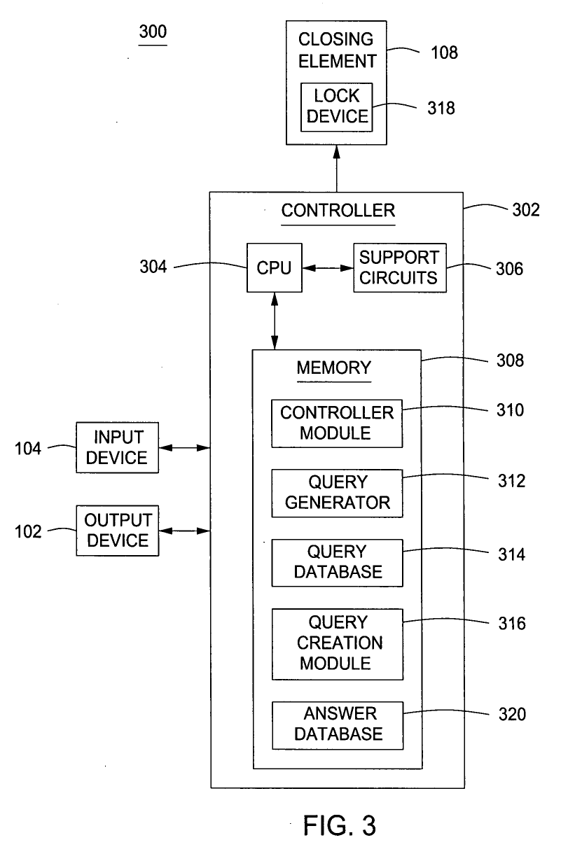

FIG. 3 is a block diagram of a computer system 300 for controlling the apparatus of FIGS. 1 and 2.

The computer system 300 comprises a controller 302. The controller 302 communicates with the closing element 108 (See FIG. 1 and FIG. 2) and/or the locking device 318. The controller 302 may also communicate with the output device 102 and/or the input device 104. The controller 302 comprises a Central Processing Unit (CPU) 304, a support circuit 306, and a memory 308. The controller 302 may compare an answer provided by a user to an answer stored in an answer database 320 within memory 308, which relates to the query displayed. If the answer entered and the answer in the database 320 are the same, or substantially similar, the controller 302 may deem the answer provided is correct; otherwise, the controller 302 may determine an answer to be incorrect. The controller 302 may utilize standards, threshold, or stored answers to determine the correctness of an answer provided by the user.

The CPU 304 may comprise one or more conventionally available microprocessors. The microprocessor may be an application specific integrated circuit (ASIC). The support circuits 306 are well known circuits used to promote functionality of the CPU 304. Such circuits include, but are not limited to, a cache, power supplies, clock circuits, input/output (I/O) circuits and the like. The memory 308 may comprise random access memory, read only memory, removable disk memory, flash memory, and various combinations of these types of memory. The memory 308 is sometimes referred to as main memory and may, in part, be used as cache memory or buffer memory. The memory 308 may store an operating system (OS), database software, various forms of application software, such as controller module 310, query generator 312, query database 314, query creation module 316, answer database 320, and the like.

Controller module 310 is executed by the controller 302. The controller module 310 facilitates communications between the controller 302 and the closing element 108, the locking device 318, the output device 102, and/or the input device 104. The query generator 312 may either generate and/or retrieve queries to and from the query database 314. The query creation module 316 retrieves queries entered by a user via the input device 104, and may store the queries in the query database 314. Thus, the query data may contain queries generated by the query generator 312 and/or queries entered via the query creation module 316. In other embodiments, the query database 314 and answer database 320 may be stored on removable storage such as a game cartridge, flash memory card, CD ROM, and the like.

In this embodiment the query generator 312, the query database 314, and the query creation module 316 are part of the controller 302. However, the query generator 312, the query database 314, and/or the query creation module 316 may be detached and coupled to the controller 302 and/or the apparatus 100. In addition, the query generator 312, the query database 314, and/or the query creation module 316 may be located in a remote location from the apparatus 100, and may communicate wirelessly with the apparatus 100 and/or controller 302.

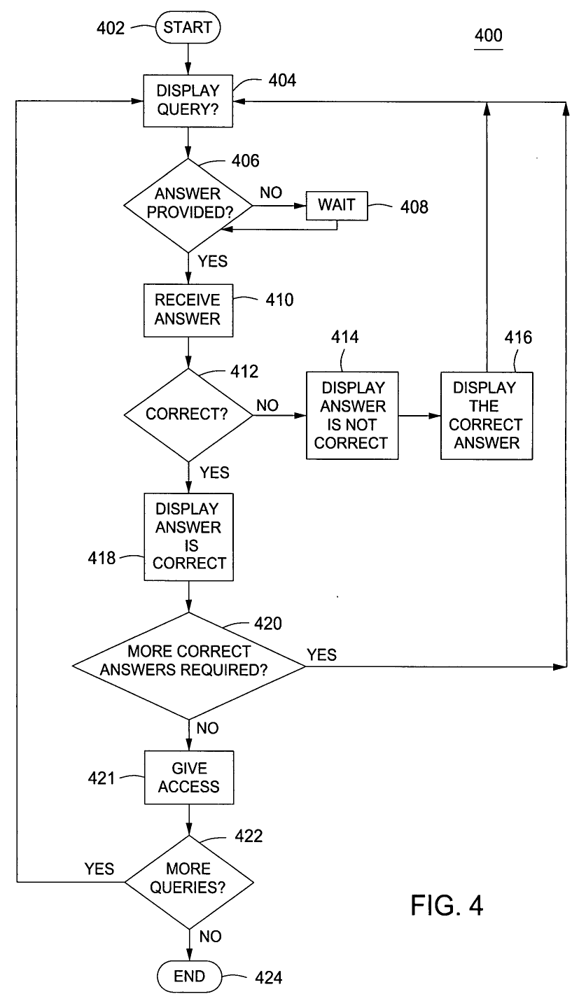

FIG. 4 is a flow of a method 400 for presenting at least one query, wherein at least one correct answer provides access to a reward retainer. The method 400 starts at step 402 and proceeds to step 404. At step 404, a query is displayed via the output device. At step 406, the method 400 checks if an answer is provided via the input device. If an answer is not provided, the method 400 waits at step 408. The method proceeds from step 408 to step 406. If an answer is provided, the method 400 proceeds to step 410. At step 410, the method 400 receives the answer provided. At step 412, the method 400 determines the correctness of the answer provided.

If an answer is incorrect, the method 400 proceeds to step 414. In step 414, the method 400 informs and/or displays to the user that the answer provided is incorrect. The method may proceed to step 416, wherein the method 400 informs the user of the correct answer. In another embodiment, the method 400 may allow a user more than one chance to answer the query correctly. In such an embodiment, the method 400 proceeds from step 414 to step 404. Otherwise, at step 416, the correct answer is displayed and the method 400 returns to step 404. From step 416, the method 400 may proceed to step 404, wherein the user is presented with a new query.

If the answer is correct, the method 400 proceeds to step 418. In step 418, the method 400 informs and/or displays to the user that the answer provided in correct. In one embodiment, the method 400 may require the user to answer multiple queries. In such an embodiment, the method 400 proceeds from step 418 to step 406, wherein the method 400 displays a new query. The method 400 may proceed from step 418 to step 420. At step 420, the method 400 may require a predetermined number of correct answers to give access to the reward retainer. If more answers are required, the method 400 proceeds to step 404. If the required number of correct answers has been answered, the method 400 proceeds to step 421. At step 421, the method 400 allows a user to gain access to the reward retainer. The reward retainer may contain an article, which may be a reward for the user for answering the query/queries correctly. The method 400 may proceed to step 422. At step 422, the user may be required to answer or asked if the user desires more queries. If the user is required to answer or requests more queries, the method 400 proceeds to step 406. Otherwise, the method 400 ends at step 424.

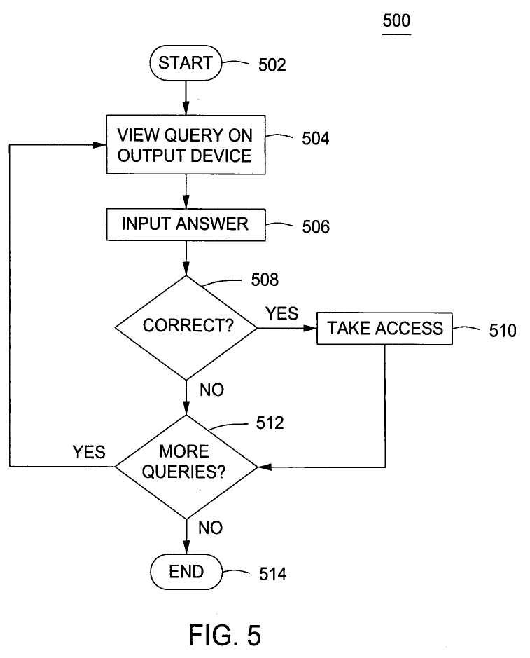

FIG. 5 is a flow diagram depicting an exemplary embodiment of a method 500 for utilizing the apparatus for presenting at least one query, wherein at least one correct answer provides access to a location. The method 500 starts at step 502 and proceeds to step 504. In step 504, the user views a query on an output device. In step 506, the user enters an answer to the query via an input device. From step 508, if the entered answer is correct, the method 500 proceeds to step 510. In step 510, the user accesses an article within the reward retainer of the apparatus. In one embodiment, the user may need to answer multiple queries correctly before proceeding to step 510. In such embodiments, if the answer is correct, the method 500 may proceed from step 508 to step 504. From step 508 and/or 510, the method 500 proceeds to step 512. At step 512, the user may be required or may be asked if the user wishes to answer more queries. If more queries are requested or required, the method 500 proceeds to step 504.

While the foregoing is directed to embodiments of the present invention, other and further embodiments of the invention may be devised without departing from the basic scope thereof, and the scope thereof is determined by the claims that follow.

What is claimed is:

1. An apparatus, comprising:
at least one reward retainer for retaining an article; and
a controller for presenting at least one query, for receiving at least one answer to the at least one query, and for providing access to the at least one reward retainer in response to the correct answer to the at least one query.

2. The apparatus of claim 1, further comprising at least one of:
an output device for presenting the at least query;
an input device for entering the at least one answer for the at least one query; or
a storage device for storing the at least one answer for the at least one query.

3. The apparatus of claim 1, further comprising:
an input device for entering the at least one query; and
a storage device for storing the at least one query.

4. The apparatus of claim 2, wherein the output device uses at least one of audio, video, graphics, printer, LCD, or LED display.

5. The apparatus of claim 2, wherein the input device is at least one of a touch screen, audio receiver, a digital receiver, a keypad, or a keyboard.

6. The apparatus of claim 1 further comprising a closing element, wherein the at least one correct answer to the at least one query causes the closing element to open.

7. The apparatus of claim 6, wherein the closing element is one of a flap, straps, cage, or sliding doors.

8. The apparatus of claim 6, wherein the closing element comprises a locking mechanism.

9. The apparatus of claim 1, wherein the at least one reward retainer comprises at least one cavity.

10. A method for operating a query apparatus, comprising:
displaying at least one query to an output device;
receiving at least one answer to the at least one query from an input device; and
allowing access to at least one reward retainer in the event the at least one answer received from the input device is the at least one correct answer to the at least one query.

11. The method of claim 10, wherein the step of allowing access to the at least one reward retainer requires more than one query to be answered correctly.

12. The method of claim 10 further comprising, in the event of receiving an incorrect answer, allowing more chances to answer the at least one query.

13. The method of claim 10 further comprising receiving at least one query.

14. The method of claim 13 further comprising storing the at least one query.

15. The method of claim 10, wherein the step of allowing access to the at least one reward retainer comprises at least one of opening a closing element or unlocking a locking mechanism.

16. The method of claim 10 further comprising displaying a reward in the at least one reward retainer.

17. The method of claim 10 further comprising displaying a message informing of a reward in the at least one reward retainer.
